(19) United States
(12) Patent Application Publication
(10) Pub. No.: US 2026/0249589 A1
(43) Pub. Date: Aug. 27, 2026

(54) MULTI-LAYERED CEMENTITIOUS COMPOSITION PREFABRICATED PRISMATIC MEMBER

(71) Applicant: Chung Wai SO, Hong Kong (CN)

(72) Inventor: Chung Wai SO, Hong Kong (CN)

(21) Appl. No.: 19/162,748

(22) PCT Filed: Aug. 29, 2023
(86) PCT No.: PCT/NZ2023/050086

§ 371 Date: Sep. 5, 2025

(30) Foreign Application Priority Data
Mar. 10, 2022 (AU) 2023900651

(51) Int. Cl. B32B 13/04; B32B 1/08; B32B 13/02; E04C 2/04; E04C 2/28; E04C 3/34; E04C 3/36; F16L 9/08

(52) U.S. Cl. CPC B32B 13/04; B32B 1/08; B32B 13/02; E04C 2/044; E04C 2/28; E04C 3/34; E04C 3/36; F16L 9/08; B32B 2597/00

(57) ABSTRACT

A multi-layered composite member that includes cementitious layer that expands when cured. The composite member includes an inner layer having a first cementitious material and an outer layer, the inner layer substantially covers an inner surface of the outer layer and the first cementitious material is an expansive material that exerts a force against the inner surface of the outer layer. Also, the preparation of the composite member and use of the composite member, e.g., as a pipeline or building component, are disclosed.

### TECHNICAL FIELD

The present invention relates to a multi-layered composite member comprising a cementitious layer that expands when cured. The invention also relates to the preparation of the composite member and use of the composite member, e.g., as a pipeline or building component.

### BACKGROUND ART

Pipelines are vital infrastructure and may be used to transport and distribute commodities such as oil, gas and water. Pipelines used for these purposes often experience severe mechanical load and environmental stresses. As a result, both metal pipes and concrete pipes are susceptible to problems such as cracking, spalling, and debris built-up. Metal pipes may corrode or deform.

In the various applications in which pipeline infrastructures are utilised, failures in the pipeline can lead to significant costs, environmental damage and/or safety issues. Leakage of drinking water is a well-known problem, e.g., in major cities such as Boston about 70 million gallons of drinking water has been lost daily since the late 1970's. Leakage from underground sewage lines can cause contamination of the aquifer. Leaking from gas lines is known to result in massive fires.

One option for addressing failures in pipeline infrastructure is repairing or retrofitting existing pipelines with a sprayable cementitious material. WO 2021/167635 A1 describes a process for repairing and retrofitting existing pipelines with fibre-reinforced engineered cementitious composites (ECCs). The process described in WO 2021/167635 A1 may be used to provide a repaired or retrofitted pipeline having, for example, higher loading and deflection capacity compared to the original pipeline and, therefore, reducing incidents of failure in the pipeline.

However, in some instances it would be beneficial to provide a pre-fabricated pipeline having improved properties that can bear higher internal and/or external loading compared to traditional pipelines.

It is an object of the present invention to go some way to satisfying this desideratum; and/or to at least provide the public with a useful choice.

Other objects of the invention may become apparent from the following description which is given by way of example only.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date.

### SUMMARY OF THE INVENTION

In a first aspect, the present invention provides a composite member comprising:
an inner layer comprising a first cementitious material and
an outer layer, wherein the inner layer substantially covers an inner surface of the outer layer and the first cementitious material is an expansive material that exerts a force against the inner surface of the outer layer.

In a second aspect, the present invention provides a method of manufacturing a composite member according to the first aspect, the method comprising:
spraying an uncured mixture of the first cementitious material onto the inner surface of the outer layer, and
curing the first cementitious material to obtain the composite member.

In a third aspect, the present invention provides a method of manufacturing a composite member comprising an inner layer comprising a first cementitious material that expands when cured, a formwork layer and an outer layer, wherein the inner layer contacts an outer surface of the formwork layer and an inner surface of the outer layer, wherein the method comprises:
providing the formwork layer and the outer layer with a cavity between the two layers,
casting an uncured mixture of the first cementitious material into the cavity between the formwork layer and the outer layer, and
curing the first cementitious material to provide the composite member.

In a fourth aspect, the present invention provides a composite member prepared according to the second or third aspect.

In some embodiments, the first cementitious material has a maximum expansion of at least about 1200 με. In some other embodiments, the first cementitious material has a maximum expansion of at least about 3000με, about 3375με, about 4000με, or about 4450με.

In some embodiments, the outer layer comprises a second cementitious material. In some embodiments, the second cementitious material shrinks when cured. In some embodiments, the second cementitious material has a shrinkage of less than about 500 μm when cured. In some embodiments, the second cementitious material has a shrinkage of about 50 to about 500 μm when cured. In some embodiments, the second cementitious material has a shrinkage of about 100 to about 400 μm when cured. In some embodiments, the second cementitious material has a shrinkage of about 50 μm, about 100 μm, about 150 μm, about 200 μm, about 250 μm, about 300 μm, about 350 μm, or about 400 μm when cured.

In some embodiments, the second cementitious material has a shrinkage of less than about 1000 με when cured. In some embodiments, the second cementitious material has a shrinkage of less than about 500 με when cured. In some embodiments, the second cementitious material has a shrinkage of about 50 to about 500 με when cured. In some embodiments, the second cementitious material has a shrinkage of about 100 to about 400 με when cured. In some embodiments, the second cementitious material has a shrinkage of about 50 μm, about 100 με, about 150 με, about 200με, about 250με, about 300με, about 350με, or about 400με when cured. In some embodiments, the second cementitious material has a shrinkage of about 300 to about 350 με when cured.

In some embodiments, the first cementitious material and/or the second cementitious material comprises a composite binder. In some embodiments, the composite binder comprises a cement component and a pozzolan component. In some embodiments, the cement component comprises a hydraulic cement.

In some embodiments, the first cementitious material and/or the second cementitious material comprise fibres.

In some embodiments, the first cementitious material and/or the second cementitious material comprise a fibre-reinforced engineered cementitious composite.

In some embodiments, the first cementitious material and/or the second cementitious material is sprayable.

In some embodiments, the cement component of the first cementitious material comprises an expansion agent. In some embodiments, the expansion agent is a calcium sulfoaluminate.

In some embodiments, the inner layer covers substantially all of the inner surface of the outer layer. In some embodiments, the outer layer substantially coats all of the outer surface of the inner layer.

In some embodiments, the outer layer comprises a metal, a polymer, a composite or a combination of any two or more thereof. In some embodiments, the metal is steel. In some embodiments, the polymer is polyvinyl chloride (PVC). In some embodiments, the composite is a fibre-reinforced plastic.

In some embodiments, the formwork layer comprises a metal, a polymer, a composite or a combination of any two or more thereof.

In some embodiments, the composite member is pre-fabricated.

In some embodiments, the composite member is hollow. In some embodiments, the composite member is solid. In some embodiments, the composite member is in the shape of a pipe, column or slab. In some embodiments, the cross section of the composite member is circular, oval, square, rectangular, pentagonal, hexagonal, heptagonal, or octagonal.

In a yet further aspect, the present invention provides use of the composite member of the first or fourth aspect as a pipe, wherein the composite member is hollow.

In some embodiments, the cross-section of the composite member is circular.

In some embodiments, the pipe is for conveying water, gas or oil.

In a further aspect, the present invention provides use of the composite member of the first or fourth aspect as a building component.

In some embodiments, the building component is a column or a slab.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

In addition, where features or aspects of the invention are described in terms of Markush groups, those persons skilled in the art will appreciate that the invention is also thereby described in terms of any individual member or subgroup of members of the Markush group.

As used herein “(s)” following a noun means the plural and/or singular forms of the noun. As used herein the term “and/or” means “and” or “or” or both.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Although the present invention is broadly as defined above, those persons skilled in the art will appreciate that the invention is not limited thereto and that the invention also includes embodiments of which the following description gives examples.

### BRIEF DESCRIPTION OF THE DRAWINGS

The invention will now be described with reference to the Figures in which:

FIG. 1 shows a two-layered composite member.

FIG. 2 shows a three-layered composite member.

FIG. 3 shows different geometries of three-layer composite members, specifically: (a) a hollow composite member with a square cross section, (b) a hollow composite member with a hexagonal cross section, (c) a solid composite member with a circular cross section, and (d) a solid composite member with a rectangular cross section.

FIG. 4 shows a configuration of a formwork layer and outer layer that may be used for casting a three-layered composite member.

FIG. 5 illustrates the shrinkage/expansion of sprayable ductile metal-like cementitious compositions (SDMCCs) prepared with OPC and CSA-K cement (wherein CSA-K comprises 7, 10, and 13 wt % of a composite binder, respectively).

FIG. 6 illustrates the shrinkage/expansion of SDMCCs prepared with OPC and LC3/CSA-K cement (wherein CSA-K comprises 10 and 13 wt % of a composite binder, respectively).

FIG. 7 illustrates the shrinkage/expansion of SDMCCs prepared with CSA-R cement (wherein anhydrite comprises 0, 10, 15, and 20 wt % of the CSA-R, respectively).

### DETAILED DESCRIPTION OF THE INVENTION

The present disclosure relates to a multi-layered composite member having advantageous properties, e.g., can bear internal and external loading, that is useful for various applications, such as a pipeline or a building component (e.g. a column or slab).

The composite member comprises two or more layers including an outer layer and an inner layer in contact with the inner surface of the outer layer. The inner layer comprises a first cementitious material that expands when cured. Advantageously, the expansive force of the first cementitious material results in a mechanical coupling (friction bonding) of the inner layer and outer layer. A further potential benefit of the mechanical coupling is that no adhesive or mechanical anchors (e.g. fasteners or screws) are required to achieve coupling of the layers. The coupling and combined properties of the two or more layers may provide a composite member having improved properties, e.g., structural load bearing capacity, compared to a monolithic layer of the same cross-sectional dimensions and shape.

The outer layer may comprise a second cementitious material. In some embodiments, the second cementitious material shrinks when cured. Advantageously, a second cementitious material that shrinks when cured may exert a force against the outer surface of the inner layer resulting in a compression/coupling effect. Alternatively, the outer layer may comprise a conventional building material, including but not limited to, metals (e.g. steel), polymers (e.g. PVC), composites (e.g. fibre-reinforced plastic) or a combination of two or more thereof. Advantageously, the combination of the inner layer comprising a first cementitious material and an outer layer comprising a conventional building material may provide improved properties compared to the conventional building material alone. For example, the composite member may provide corrosion protection, e.g., in a composite member comprising a first cementitious material layer and a metal layer compared to a metal alone (such as a steel pipe). The composite member may also provide increased stiffness, e.g., in a composite member comprising a first cementitious material layer and a PVC layer compared to PVC alone (such as a PVC pipe).

The first cementitious material is a cementitious material that expands when cured. The first cementitious may have a maximum expansion of at least about 1200 με, e.g., a maximum expansion of at least about 3000με, about 3375με, about 4000με, or about 4450με. Those persons skilled in the art will appreciate conventional cementitious materials with suitable expansion properties may be useful in the composite member. For example, the first cementitious material may comprise a hydraulic cement and an expansion agent. In some embodiments, the expansion agent is a calcium sulfoaluminate. Preferably, the first cementitious material is a sprayable ductile metal-like cementitious composition (SDMCC) as described in WO 2021/167635 A1.

Those persons skilled in the art will appreciate that the first and second cementitious materials may be prepared from conventional cementitious materials, provided the required expansion and shrinkage properties are achieved. For example, the first and/or second cementitious material may be a fibre-reinforced composite such as an engineered cementitious composite (ECC). Exemplary formulations of the cementitious material are described in further detail below.

The exact shape, dimension, and number and material of the layers may be selected to meet the performance requirement of the application of the composite member.

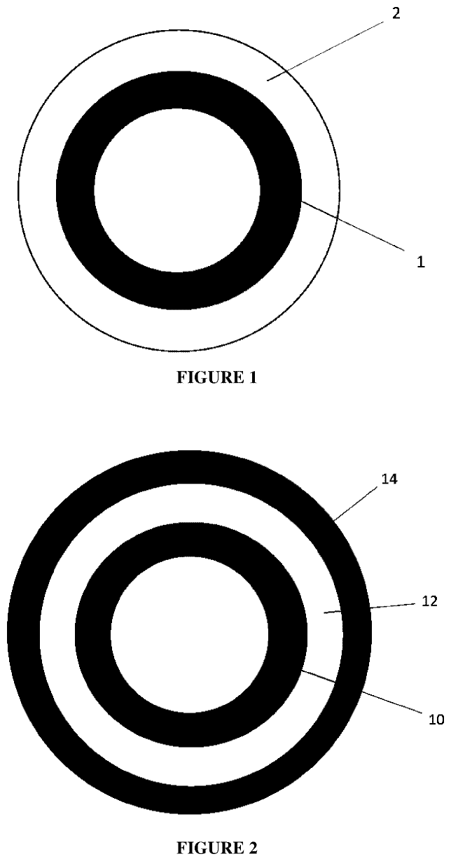

The composite member comprises at least two layers as shown in FIG. 1 with an inner layer (1) and an outer layer (2). However, the composite member may comprise other combinations of layers depending on the intended application and desired properties of the composite material. For example, the composite member may comprise three layers as shown in FIG. 2 with an inner layer (10), an outer layer (12) and a coating layer (14) comprising a second cementitious material that shrinks when cured.

In some embodiments, the composite member may comprise a further inner layer. The further inner layer may be useful, e.g., as a permanent formwork layer for casting the inner layer. In some embodiments, the inner layer contacts an outer surface of the formwork layer and an inner surface of the outer layer. The formwork layer may, e.g., comprise a material capable of taking tension from the expanding inner layer. Those persons skilled in the art will be familiar with formwork and can select suitable materials for the formwork layer. Suitable materials for the formwork layer include, but are not limited to, metals (e.g. steel), polymers (e.g. PVC), composites (e.g. fibre-reinforced plastic) or a combination of two or more thereof.

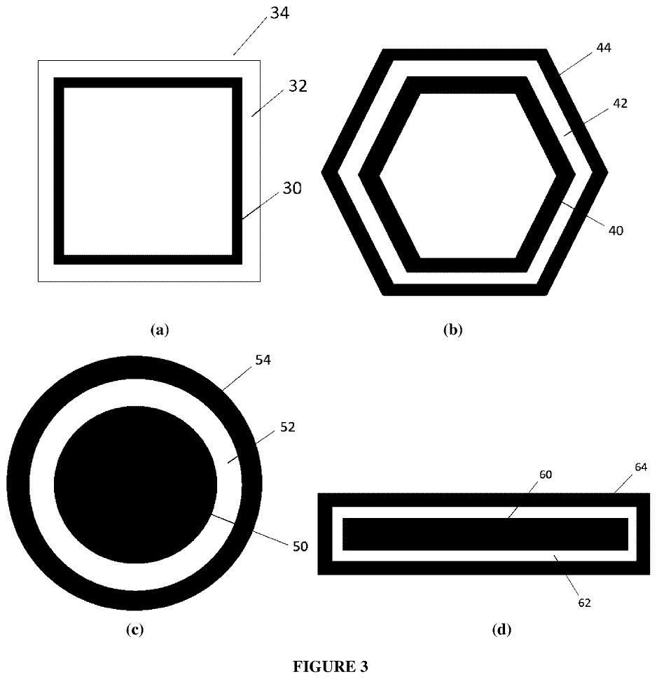

The cross-section of the composite member can be circular, rectangular or any other shape. For some applications, the composite member is hollow, e.g., as shown in FIGS. 1, 2, 3(a) and 3(b). FIG. 3(a) shows a composite member with a square cross section comprising an inner layer (30) comprising the first cementitious material, an outer layer (32) and a coating layer (34) comprising the second cementitious material. FIG. 3(b) shows a composite member with a hexagonal cross section comprising an inner layer (40) comprising the first cementitious material, an outer layer (42) and a coating layer (44) comprising the second cementitious material. Such applications include in pipelines, such as civil or industrial pipeline infrastructure for conveying drinking or wastewater, or pipelines for other fluids such as gas or oil. For some applications the composite member is solid. For example, the composite member may be provided as a solid column or slab, as shown in FIGS. 3(c) and 3(d), useful as a building component. FIG. 3(c) shows a composite member with a circular cross section comprising an inner layer (50) comprising the first cementitious material, an outer layer (52) and a coating layer (54) comprising the second cementitious material. FIG. 3(d) shows a composite member with a rectangular cross section comprising an inner layer (60) comprising the first cementitious material, an outer layer (62) and a coating layer (64) comprising the second cementitious material. Although the composite members shown in FIGS. 2 and 3 have been described with as comprising an inner layer, an outer layer and a coating layer, these three-layered composite members could be provided with other combinations of layers. For example, the composite member shown in FIG. 2 may comprise a formwork layer (10), an inner layer (12) and an outer layer (14). Accordingly, those persons skilled in the art will appreciate that the shape, dimension, and number and material of the layers of the composite member may be selected according to the intended application.

### Hydraulic Cement

Hydraulic cements are materials that set and harden when mixed with water. Hydraulic cements include, but are not limited to, Portland cement, blended Portland cement, phosphate cement, and belite cement (dicalcium silicate). Mixtures of any two or more thereof are also contemplated. Preferably, the hydraulic cement is a Portland cement.

Portland cement is a finely ground powder produced by grinding clinker consisting essentially of hydraulic calcium silicates. The cement may contain up to about 5% gypsum. The amount of gypsum present affects the set time. The standards for Portland cement are defined in ASTM C 150, Standard Specification for Portland Cement, which defines eight types of Portland cement: type I, type IA, type II, type IIA, type III, type IIIA, type IV, and type V. Type I cement is a general purpose ordinary Portland cement (OPC) suitable for all uses where the special properties of other types are not required. Type III cements are chemically and physically similar to Type I cements except they are ground finer to produce higher early strengths.

The cement component of the cementitious material may comprise a hydraulic cement in an amount of, based on the total cement component weight, about 1 to about 80 wt %, about 20 to about 80 wt %, about 50 to about 80 wt %, or about 60 to about 80 wt %.

In some embodiments, the cement component comprises a reactive aluminosilicate such as calcined clay and/or a calcium carbonate such as limestone. Advantageously, replacing a portion of the hydraulic cement with a reactive aluminosilicate and/or calcium carbonate provides a more environmentally friendly composition by reducing the amount of carbon released during the manufacturing process.

Cementitious material comprising a reactive aluminosilicate and/or calcium carbonate may provide other advantages. For example, limestone calcined clay cement (LC3) paste has been found to have a finer pore structure than paste made with OPC. Advantageously, the pore refinement provides excellent resistance to chloride ingress and good performance in the presence of sulfates, which is especially significant for the complex environment in pipelines.

Additionally, cementitious material comprising LC3 has surprisingly been found to have larger strain capacity and smaller crack width than prior art ECCs prepared with OPC. The decreased crack width results in a lower permeability. The larger strain capacity cementitious material is expected to have larger deformability. This may result, e.g., in a composite member having a higher loading and deflection capacity.

The cement component may comprise a reactive aluminosilicate, a calcium carbonate, or a mixture thereof in an amount of, based on the total cement component weight, about 1 to about 80 wt %, about 30 to about 60 wt %, or about 40 to 50 wt %. For example, the cement component may comprise a reactive aluminosilicate in an amount of, based on the total cement component weight, about 0 to about 50 wt %, about 20 to about 40 wt %, or about 30 wt %. For example, the cement component may comprise a calcium carbonate in an amount of, based on the total cement component weight, about 0 to about 30 wt %, about 10 to about 20 wt %, or about 15 wt %. In some embodiments, the ratio of reactive aluminosilicate to calcium carbonate is 2:1.

In some embodiments, the average particle size of the reactive aluminosilicate is about 2 μm to about 40 μm, or about 2 μm to about 10 μm. In some embodiments, the average particle size of the calcium carbonate is about 2 μm to about 100 μm, or about 2 μm to about 20 μm.

In some embodiments, the cement component comprises, based on the total cement mixture weight, about 10 to about 50 wt % OPC, about 20 to about 40 wt % metakaolin, and about 10 to about 20 wt % limestone.

In some embodiments, a portion of the hydraulic cement may be replaced with mining tailings. For example, the cement component may comprise mining tailings in an amount of, based on the total cement component weight, about 1 to about 30 wt %.

### Expansion Agent

An expansion agent is a material that augments the expansion of the cementitious material during the hydration process. In some embodiments, the expansion agent may be used to reduce shrinkage that occurs during curing of the composition. For example, an expansion agent may be used to reduce the inherent shrinkage properties of a cementitious material to provide a cementitious material suitable for use as the outer layer (i.e. the second cementitious material). In other embodiments, the expansion agent may be used to provide a cementitious material that expands during curing. Advantageously, augmenting the expansion of the cementitious material may reduce the risk of cracking that occurs during shrinkage.

The expansion agent may be used to tailor the expansive properties of the first cementitious material such that, when applied to the inner surface of the outer layer and cured, the cementitious material exerts an expansive force against the outer layer. The expansive force reduces any space between the cementitious material and the outer layer, and increases the mechanical friction between them. Advantageously, the increased mechanical friction may increase adhesion between the cementitious material and the outer layer. As a result, the composite member may have a higher loading and deflection capacity compared with a monolithic member. Additionally, the increased adhesion may reduce delamination of the cementitious material from the outer layer, as well as wrinkle and even buckling of the composite member. However, those persons skilled in the art will appreciate that, in some embodiments, excessive expansion should be avoided because it may lead to deformation of the outer layer. Accordingly, the amount of expansive force that is desirable will depend, in part, on the material properties of the outer layer.

Preferred expansion agents include calcium aluminate cement (CAC) and calcium sulfoaluminate cement (CSA). Preferably the expansive agent is CSA. The amount of CaSO₄·nH₂O in the CSA is, preferably, based on the weight of the CSA, about 1 to 50 wt %, wherein n may be 0, 0.5, 1 or 2.

The first cementitious material may comprise an expansive agent in an amount of, based on the total cement component weight, about 10 to about 60 wt %, or about 20 to about 50 wt %. In some embodiments, the average particle size of the expansion agent is about 2 μm to about 500 μm, or about 10 μm to about 30 μm.

### Pozzolans

Pozzolans are siliceous or siliceous and aluminous materials that are typically provided in a finely divided form. Pozzolans alone have little or no cementitious properties, However, in the presence of water, pozzolans react with calcium hydroxide released by the hydration of hydraulic cement to form calcium silicate hydrate and other cementitious compounds. Advantageously, pozzolans may improve the binder fracture toughness of cementitious materials leading to higher ductility of the cured cementitious material. Pozzolans may also be used to modulate the rheology of the cementitious material. Advantageously, the rheology of the cementitious material may be modulated to improve the pumpability and/or sprayability of the composition.

Generally, any siliceous or siliceous and aluminous materials that react with calcium hydroxide in the presence of water may be suitable for use in the binder. Examples of suitable pozzolans include, but are not limited to, fly ash, steel slag, granulated blast furnace slag, diatomaceous earth, silica fume, calcined clay such as metakaolin, calcined shale, volcanic ash, pumice, burnt silica-rich organic matter such as rice husk ash, and mixtures of any two or more thereof. Preferably, the pozzolan component comprises a fly ash, e.g., as defined in ASTM C618. In some embodiments, the fly ash is type C fly ash and/or type F fly ash.

In some embodiments, the pozzolan component comprises silica fume. Advantageously, silica fume may increase the compressive strength of the cementitious material and/or improve the fibre/matrix interface bond in those embodiments wherein the first cementitious material comprises fibres.

The composite binder may comprise the pozzolan component in an amount of about 0 to about 3 times the weight of the cement component. Preferably, the composite binder comprises the pozzolan component in an amount of about 1 to about 3 times, by weight, the cement component, more preferably about 2 to about 3 times, more preferably about 2 to about 2.5 times.

### Fibres

The fibres are intended to reinforce the cured cementitious material. Suitable fibres may be selected based on various characteristics, including the desired cost, mechanical properties, physical properties and bond properties of the fibres. The properties of the cementitious material may be influenced by factors such as the length, diameter, chemical composition, stiffness, density, and strength of the fibres. The fibres may be selected to transmit load across cracks when the composite is loaded to beyond the elastic stage. Their load-carrying behaviour may be tuned to balance fibre fracture and fibre slippage, i.e. controlled fibre bridging behaviour. During imposed loading on the composite, excessive fibre fracture or fibre slippage is undesirable, as this may limit the composite ductility or result in crack width that is excessively large as to compromise composite durability. Advantageously, the fibres may improve the strain hardening and tensile ductility of the composite member, and limit crack width.

Fibres suitable for use in the cementitious material include, but are not limited to, polymeric fibres, inorganic fibres (e.g. basaltic fibres and glass fibres), metal fibres (e.g. steel fibres), carbon fibres, plant-based fibres (e.g. cellulosic fibres and lignocellulosic fibres), and mixtures of any two or more thereof. Preferably, the fibres are polymeric fibres, i.e. fibres composed of a polymeric material such as a polyolefin (e.g. polyethylene or polypropylene), a polyacrylic, a polyester, a polyvinyl alcohol, a polyamide (e.g. nylon), or combinations of any two or more thereof. More preferably, the fibres are polypropylene fibres, more preferably high tenacity polypropylene fibres. In some embodiments, the fibres are short discontinuous fibres.

The upper limit of fibre concentration is dictated by pumpability and sprayability requirements, while the lower limit is dictated by the ability to provide strain hardening (ductile) behaviour as opposed to brittle or quasi-brittle behaviour. For example, the fibres may be present in an amount of, based on the total composition volume (i.e. the volume of the composition including water), from about 0.1 to less than 4 v/v %, about 1 to about 3 v/v %, or about 1.5 to about 2.3 v/v %. In some embodiments, the fibre length is about 4 mm to about 25 mm, about 6 mm to about 20 mm, or about 8 mm to about 12 mm. In some embodiments, the fibre diameter is about 10 μm to about 150 μm, or about 10 μm to about 60 μm.

### Superplasticizer

In some embodiments, the cementitious material further comprises a superplasticizer, also known as a high range water reducer. A superplasticizer may be added to the cementitious material to affect the rheology of the composition. Advantageously, the superplasticizer may reduce the amount of water that is required to maintain the pumpability and sprayability of the cementitious material.

Accordingly, the superplasticizer is typically added to the cementitious material in an amount effective to achieve a composition with the desired pumpability and sprayability. Those persons skilled in the art will appreciate the amount of superplasticizer required to achieve the desired pumpability and sprayability may depend on other components of the composition, such as the water content of the composition. For example, the superplasticizer may be included in the cementitious material in an amount of, based on the total composition weight, about 0.1 to 10 wt %, about 0.3 to about 3 wt %, or about 0.5 to about 1.5 wt %.

Generally, any superplasticizer known in the art is suitable for use in the cementitious material. Such superplasticizers include, but are not limited to, sulfonated melamines (e.g. sulfonated melamine formaldehyde condensates), sulfonated naphthalenes (e.g. sulfonated naphthalene formaldehyde condensates), polycarboxylate ethers (e.g. ADVA® 190), modified lignosulfonates, and mixtures of any two or more thereof.

### Aggregate

The cementitious material may further comprise aggregate, such as sand, ground stone and lightweight aggregate. Incorporation of lightweight aggregates may decrease the density of the cementitious material. Incorporation of lightweight aggregates may also allow increased thicknesses to be sprayed, particularly on horizontal overhead surfaces. If the amount of lightweight aggregate is significant, then the particle size becomes important, otherwise strain hardening cannot be achieved. In general, the average particle size is about 10 μm to about 1000 μm, or about 10 μm to about 200 μm, or about 30 μm to about 100 μm.

Lightweight aggregates may comprise, but are not limited to, grounded rubber (e.g. from waste tires), hollow glass spheres, cenosphere, expanded mica, and microballoons (e.g. glass, ceramic or polymer microballoons).

In addition to, or instead of, lightweight aggregate, the cementitious material may further comprise gas bubbles. The gas may be introduced during processing of the cementitious material by physical means, e.g. frothing or aeration. Alternatively, the gas may be chemically induced, e.g. as hydrogen gas created by reaction of aluminium powder with the alkaline composition or reaction of Si—H functional silanes with water. In some embodiments, stabilising substances are added to assist in preventing coalescence of adjoining bubbles. In some embodiments, the volume percent is limited to provide a cured density of about 1400 kg/m³ or higher, preferably 1500 kg/m³ or higher. If significant coalescence to large voids occurs, strength properties of the composite, particularly strain hardening behaviour, may be compromised. Gas bubbles may be used in conjunction with other lightweight aggregates. Advantageously, the volume fraction of gas bubbles in such formulations can be kept small so that coalescence will be minimal. For example, in a composite with a target density of 1300 kg/m³, a gas or gas precursor may be added to obtain a density of about 1600 kg/m³ or higher, and other lightweight filler added to lower the density to the target range.

### Other Additives

The cementitious material may further comprise other additives as are known in the art, such as a viscosity agent and/or a retarder agent.

For example, the viscosity agent may be a cellulose derivative, such as hydroxypropyl methylcellulose (HPMC). The viscosity agent may be included in the cementitious material in an amount of, based on the total binder weight (i.e. the weight of the composition excluding water), about 0 to about 1 wt %, or about 0.03 to about 0.5 wt %, or about 0.05 to about 0.2 wt %. The viscosity agent enhances the ability of the composite to build up thickness on a substrate, and also helps the fibres disperse evenly in the matrix.

The cementitious material may comprise a retarder agent. A conventional retarder agent can be used. A preferred retarder agent is citric acid, which, advantageously, is compatible with use of CSA. The retarder agent may be included in an amount of, based on the total binder weight, about 0.01 to about 10 wt %, about 0.1 to about 2 wt %, or about 0.2 to about 1.5 wt %. The retarder agent can increase the working time of the cementitious material during a spray process. However, those persons skilled in the art will appreciate that excess retarder agent may decrease the strength and ductility of the cementitious material.

### Water

The amount of water in the cementitious material affects various properties of the composition. In some embodiments, the water content should be sufficient to obtain a pumpable and sprayable composition. In general, a higher water content reduces the viscosity and increases sprayability, while a lower water content increases cohesion and allows for thicker application. The amount of water required to provide a pumpable and sprayable composition may be readily determined by routine experimentation and may be decreased by including a superplasticizer as discussed above.

In some embodiments, the water-to-binder ratio is about 0.2 to about 0.5. Preferably, the water-to-binder ratio is about 0.2 to about 0.4, more preferably about 0.3.

### Preparation of the Cementitious Materials

The cementitious materials of the present invention can be prepared by conventional techniques. The ingredients may be mixed with water separately or certain ingredients may be pre-mixed. In some embodiments, water is added to a pre-mix of the dry binder ingredients to obtain a wet mixture, to which the fibres are added. In some embodiments, a superplasticizer is mixed with water to form a solution that is added to a pre-mix of the dry binder ingredients to obtain a wet mixture, to which the fibres are added. In some other embodiments, the dry ingredients may be provided in a “ready-mix” composition, e.g. a pre-mix of the dry binder ingredients and the fibres, that is mixed with water prior to use to form the cementitious material.

### Preparation of the Composite Member

The composite member may be prepared by spraying the first cementitious material on the inner surface of the outer layer. The first cementitious material is cured to form the inner layer and provide the composite member. Advantageously, when the first cementitious material is an SDMCC, the curing process is exothermic and does not require heat input to initiate the hydration and pozzolanic chemical reactions for curing. In this process, the outer layer acts as a permanent formwork. When the composite material comprises a coating layer, the second cementitious material is sprayed onto the outer surface of the outer layer and cured to form the coating layer. The first and second cementitious materials may be sprayed onto the inner surface and the outer surface, respectively, of the outer layer concurrently or sequentially in any order.

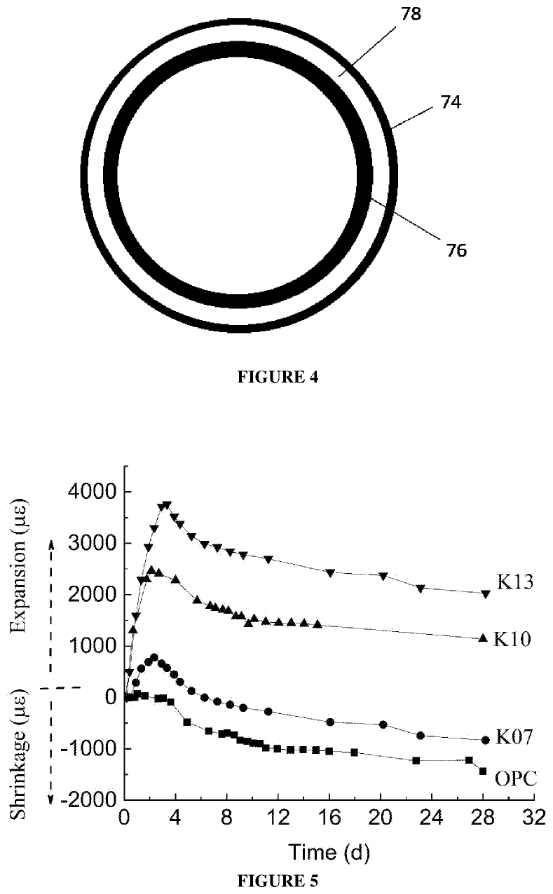

Alternatively, the composite member may be prepared by a casting process. For example, as shown in FIG. 4, an outer layer (74) and a formwork layer (76) may be provided with a cavity (78) between the two layers. The first cementitious material may be cast into the cavity (78) and cured to provide the composite member. In some embodiments, the process may further comprise spraying the second cementitious material onto the outer layer and curing the cementitious material.

The following non-limiting examples are provided to illustrate the present invention and in no way limit the scope thereof.

### EXAMPLES

### 1. Material Composition and Processing

The exemplary mixtures are listed in Table 1. The cement was Type I Portland cement (PC1) from Lafarge Cement Co., MI, USA. Two classes of expansive cement from CTS Cement Manufacturing Corp, and from Royal White Cement Inc were used and defined as CSA-K and CSA-R, respectively. Metakaolin (MK) was Sikacrete® M-100 from Sika Corporation, NJ, USA. Anhydrite was Terry-Alba No. 1 from USG. Limestone (LS) was Snowhite® 12-PT from Omya Canada Inc. Fly ash (FA) was class C fly ash with a size distribution from 10 to 100 μm from Boral Material Technologies Inc. The superplasticizer (SP) was AVDAR 190 from GCP Applied Technologies. Hydroxypropyl methylcellulose (HPMC), a viscosity agent, was from Fisher Scientific. The amount of polypropylene (PP) fibres was 2% volume fraction with 12 μm diameter, 10 mm length, 6 GPa Young's modulus, and 850 MPa tensile strength, and was Brasilit from Saint-Gobain Brazil.

TABLE 1

| | Composite Binder | | | | | | | | | PP fibres |
|---|---|---|---|---|---|---|---|---|---|---|
| Materials | PC1 | CSA | Anhydrite | MK | LS | FA | Water | SP | HPMC | (Vol %) |
| OPC | 1 | 0 | 0 | 0 | 0 | 2.2 | 0.96 | 0 | 0.0016 | 2 |
| K07 | 0.78 | 0.22 | 0 | 0 | 0 | 2.2 | 0.96 | 0 | 0.0016 | 2 |
| K10 | 0.68 | 0.32 | 0 | 0 | 0 | 2.2 | 0.96 | 0 | 0.0016 | 2 |
| K13 | 0.58 | 0.42 | 0 | 0 | 0 | 2.2 | 0.96 | 0 | 0.0016 | 2 |
| LC3 | 0.55 | 0 | 0 | 0.3 | 0.15 | 2.2 | 0.96 | 0 | 0.0016 | 2 |
| LC3-K10 | 0.23 | 0.32 | 0 | 0.3 | 0.15 | 2.2 | 0.96 | 0.01 | 0.0016 | 2 |
| LC3-K13 | 0.13 | 0.42 | 0 | 0.3 | 0.15 | 2.2 | 0.96 | 0.01 | 0.0016 | 2 |
| R13-C0 | 0.58 | 0.42 | 0 | 0 | 0 | 2.2 | 0.96 | 0 | 0.0016 | 2 |
| R13-C10 | 0.58 | 0.38 | 0.04 | 0 | 0 | 2.2 | 0.96 | 0 | 0.0016 | 2 |
| R13-C15 | 0.58 | 0.36 | 0.06 | 0 | 0 | 2.2 | 0.96 | 0 | 0.0016 | 2 |
| R13-C20 | 0.58 | 0.34 | 0.08 | 0 | 0 | 2.2 | 0.96 | 0 | 0.0016 | 2 |

The nomenclature in Table 1 reflects the binder composition. OPC and LC3 refer to binders prepared with ordinary Portland cement and limestone calcined clay cement, respectively. K07, K10, and K13 refer to a CSA-K to binder ratio of 7, 10, and 13 wt %. R13-C0, 10, 15, and 20 represent a CSA-R and anhydrite to binder ratio of 13 wt %, wherein the anhydrite proportion is 0, 10, 15, and 20 wt % of the total weight of CSA-R and anhydrite. The wt % ratio of PC1, MK, and LS in LC3 cement is 55%, 30%, and 15%.

The SDMCC was prepared by mixing all the dry ingredients (PC1, CSA, anhydrite, MK, LS, FA, and HPMC) in a drum mixer for 10 minutes. Water together with SP was added gradually and mixed for 6 minutes. PP fibres were added last, then mixed for 6 minutes.

### 2. Expansion Characteristics

The specimens for measuring shrinkage/expansion were cast into a prism mould (25×25×300 mm). The shrinkage/expansion measurements were taken after demoulding as early as possible without damaging the specimens and marked as the “zero time” of the deformation. For the mixtures in Table 1, the demoulding time was 20 hours for OPC; 10 hours for K07; 5 hours for K10, K13, and LC3-K13; 8 hours for LC3-K10; 3 hours for R13-C0, R13-C10, R13-C15, and R13-C20. The specimens were stored in a 20±2° C. and 40±5% relative humidity (RH) environment. The length changes of the specimens were tested according to ASTM C490/C490M-17.

### 2.1 Drying Shrinkage/Expansion

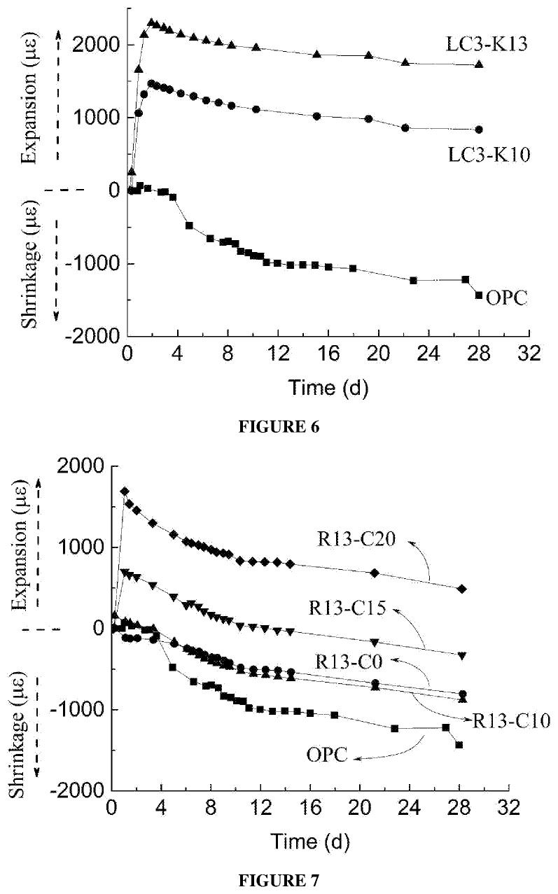

The shrinkage/expansion versus age curves of the compositions in Table 1 are shown in FIGS. 5-7, wherein the negative sign (on the y-axis) represents shrinkage and the positive sign represents expansion. Table 2 lists the characteristic values of shrinkage/expansion at 28 days. For the SDMCC prepared with OPC, the shrinkage continuously increased to −1434 με at 28 days. Such relatively large shrinkage could lead to cracking under restrained conditions, which decreases the durability of the material. The SDMCC utilising CSA-K showed the characteristics of expansion initially followed by shrinkage. The maximum expansion occurred around 2 days age. The magnitude of the maximum expansion was 779με, 2418με, and 3756με for compositions K07, K10, and K13, varying with the CSA-K ratios. However, with 7 wt % CSA-K cement in the composite binder, the SDMCC still showed-832 με shrinkage at 28 days. The expansion of K10 and K13 was 1139 με and 2026 με, respectively, at 28 days. The expansion of ECC employing LC3 was a little lower than OPC. The expansion was 838 με and 1722 με for LC3-K10 and LC3-K13.

The type of CSA cement may also influence the magnitude of expansion. CSA-R is a CSA binder with less CaSO₄ than CSA-K. Even when the content of CSA-R was 13 wt % of the composite binder (R13-C0), the shrinkage of R13-C0 was −834 με at 28 days and did not show expansion. Increased replacement of CSA-R with anhydrite, reduced the shrinkage and R13-C20 had a 489 με expansion at 28 days. Without wishing to be bound by theory, it is thought the CaSO₄ (gypsum or anhydrite) amount in CSA cement affects the production of ettringite. Ettringite is the main expansive hydration product of CSA cement.

### 2.2 Minimum Expansion

Assuming linear material constitutive behaviour, the pressure caused by expansion can be expressed as:

$$p = {E}_{1} {ε}_{1} - {E}_{2} {ε}_{2} \qquad ( 1 )$$

where p is the pressure applied from expansive SDMCC; ε1 is the maximum expansion of SDMCC; ε₂ is the difference between maximum expansion and the residual strain at 28 days; E₁ is the effective modulus between time zero and maximum expansion time and; E₂ is the effective modulus between maximum expansion time and 28 days. ε₁ and ε₂ can be tested by the drying shrinkage/expansion test according to ASTM C490/C490M-17, and the values are listed in Table 2. E₁ and E₂ are the effective modulus, influenced by stress relaxation and time development. During early age (before 3 days), creep is more significant than at later age (3-28 days). Additionally, the elastic modulus is smaller at an early age, even for the rapid hardening SDMCC materials.

Assuming that E₁=kE₂, the pressure can also be expressed as:

$$f = ( k {ε}_{1} - {ε}_{2} ) {E}_{2} \qquad ( 2 )$$

where k is defined as the coefficient of effective modulus. k is determined by the combined effect of material elastic modulus development and boundary restrained condition. Advantageously, to ensure the SDMCC creates a coupling effect against the outer layer or formwork layer, f should be larger than 0. In other words, kε₁-ε₂ should be larger than 0. According to Zhu H. et al., Double feedback control method for determining early-age restrained creep of concrete using a temperature stress testing machine. Materials, 2018, 11(7), 1079, it seems plausible to assume k=0.5.

TABLE 2

| | Maximum | 28 day | Ultimate | Strain | Average crack | | |
|---|---|---|---|---|---|---|---|
| | expansion | expansion | tensile | capacity | width/μm | | |
| Materials | (με) | (με) | strength (MPa) | (%) | 1% | 2% | 3% |
| OPC | 71.4 | −1434 | 3.41 | 3.69 | 83 | 105 | 107 |
| K07 | 779 | −832 | 3.67 | 4.49 | 61 | 84 | 90 |
| K10 | 2418 | 1139 | 3.62 | 5.17 | 49 | 75 | 90 |
| K13 | 3756 | 2026 | 3.85 | 5.04 | 61 | 81 | 99 |
| LC3-K10 | 1470 | 838 | 2.97 | 5.20 | 61 | 75 | 85 |
| LC3-K13 | 2300 | 1722 | 2.81 | 4.68 | 51 | 72 | 89 |
| R13-C0 | 4 | −834 | | — | — | — | — |
| R13-C10 | 158 | −879 | | — | — | — | — |
| R13-C15 | 698 | −326 | | — | — | — | — |
| R13-C20 | 1691 | 489 | | — | — | — | — |

For the mixtures in Table 2, the maximum expansion and the expansion of OPC after 28 days differ from K07, K10, and K13; however, the difference between the maximum expansion and the 28 day expansion (i.e. ε₂) is similar for OPC, K07, K10, and K13. Experimentally, ε₂ is found to be approximately 1531 με for the OPC-based SDMCC and 605 με for the LC3-based SDMCC. Therefore, for the OPC-based SDMCC, the maximum expansion ε₁=ε₂/k is preferably at least 3062 με (1531/0.5) to provide a desirable coupling effect. The maximum expansion for the LC3-based SDMCC is preferably at least 1210 με (605/0.5).

### 3. Preparation of Multi-Layered Cementitious Composition Prefabricated Prismatic Member

A multi-layered cementitious composition prefabricated prismatic member may be prepared by selecting suitable compositions as exemplified in Table 1. For example, R13-C15 achieves a long-term shrinkage of 326 με and, therefore, is suitable for use as an outer layer. While OPC also shrinks, the long-term shrinkage of 1434 με may lead to cracking, which is undesirable. For the inner layer, a material with controlled expansion is desirable. LC3-K13 offers a long-term expansion of 1722 με and can serve as this inner layer.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is not the intention to limit the scope of the invention to the abovementioned examples only. As would be appreciated by a skilled person in the art, many variations are possible without departing from the scope of the invention as set out in the accompanying claims.

1. A prefabricated composite member comprising:
an inner layer comprising a first cementitious material, and
an outer layer,
wherein the inner layer substantially covers an inner surface of the outer layer and the first cementitious material is an expansive material that exerts an expansive force against the inner surface of the outer layer thereby creating a mechanical coupling, and
the outer layer comprises a second cementitious material, or
the outer layer comprises a metal, a polymer, a composite or a combination of any two or more thereof, and the prefabricated composite member further comprises a coating layer on an outer surface of the outer layer and the coating layer comprises the second cementitious material.

2. A method of manufacturing a prefabricated composite member according to claim 1, the method comprising:
spraying an uncured mixture of the first cementitious material onto the inner surface of the outer layer, and
curing the first cementitious material to obtain the composite member.

3. A method of manufacturing a prefabricated composite member comprising an inner layer comprising a first cementitious material that expands when cured, a formwork layer and an outer layer comprising a second cementitious material, wherein the inner layer contacts an outer surface of the formwork layer and an inner surface of the outer layer, wherein the method comprises:
providing the formwork layer and the outer layer with a cavity between the two layers,
casting an uncured mixture of the first cementitious material into the cavity between the formwork layer and the outer layer, and
curing the first cementitious material to provide the composite member.

4. The composite member of claim 1, wherein the first cementitious material comprises an expansion agent.

5. The composite member of claim 1, wherein the first cementitious material has a maximum expansion of at least about 1200με.

6. (canceled)

7. The composite member of claim 1, wherein the second cementitious material shrinks when cured.

8. The composite member of claim 1, wherein the second cementitious material has a shrinkage of less than about 500 μm when cured.

9. The composite member of claim 1, wherein the second cementitious material has a shrinkage of less than about 1000 με when cured.

10. The composite member of claim 1, wherein the first cementitious material and/or the second cementitious material comprises a composite binder.

11. The composite member of claim 10, wherein the composite binder comprises a cement component and a pozzolan component.

12. The composite member of claim 1, wherein the first cementitious material and/or the second cementitious material comprise fibres.

13. The composite member of claim 1, wherein the first cementitious material and/or the second cementitious material is sprayable.

14. (canceled)

15. The method of claim 3, wherein the formwork layer comprises a metal, a polymer, a composite or a combination of any two or more thereof.

16. (canceled)

17. The composite member of claim 1, wherein the composite member is hollow or solid.

18. The composite member of claim 1, wherein the composite member is in the shape of a pipe, column or slab.

19. (canceled)

20. (canceled)

21. The composite member of claim 1, wherein the cross-section of the composite member is circular.

22. The composite member of claim 1, composite member is a pipe configured for conveying water, gas or oil.

23. The composite member of claim 1, wherein of the composite member is a building component.

24. (canceled)
